(19) United States
(12) Patent Application Publication
(10) Pub. No.: US 2024/0317596 A1
(43) Pub. Date: Sep. 26, 2024

(54) LIQUEFIED AMMONIA-AMMONIUM COMPOSITION AND RELATED METHODS

(71) Applicant: BOARD OF TRUSTEES OF MICHIGAN STATE UNIVERSITY, East Lansing, MI (US)

(72) Inventors: Chenjia Mi, Okemos, MI (US); Reza Ghazfar, Lansing, MI (US); Milton R. Smith, III, East Lansing, MI (US); Thomas W. Hamann, Okemos, MI (US)

(21) Appl. No.: 18/613,688

(22) Filed: Mar. 22, 2024

Related U.S. Application Data
(60) Provisional application No. 63/454,118, filed on Mar. 23, 2023.

(51) Int. Cl. C01C 1/10; C01C 1/00; C25B 1/02

(52) U.S. Cl. CPC C01C 1/10; C01C 1/003; C25B 1/02

(57) ABSTRACT

The disclosure relates to a liquefied ammonia-ammonium composition, also referenced herein as a eurefstic composition. The composition includes ammonia, an ammonium cation, and a halogenated anion, and the composition remains in liquid form at ambient temperatures and pressures. The composition can be formed by contacting gaseous ammonia with a solid halogenated ammonium salt, such as ammonium triflate or ammonium hexafluorophosphate, which absorbs the ammonia to form the liquid eurefstic composition. The eurefstic composition provides a convenient, safe, and ammonia-dense liquid that is easily transportable and safely storable until later use, for example to release and generate ammonia, to be electrolyzed to generate hydrogen gas, etc. The ammonia or hydrogen gas can then be used as a combustion fuel or other energy source.

### CROSS REFERENCE TO RELATED APPLICATION

This application claims the benefit under 35 U.S.C. § 119(e) of U.S. Provisional Patent Application No. 63/454,118, filed Mar. 23, 2023, the entire disclosure of which is incorporated herein by reference.

### STATEMENT OF GOVERNMENT INTEREST

This invention was made with government support under DE-SC0016604 awarded by Department of Energy, Basic Energy Sciences. The government has certain rights in the invention.

### BACKGROUND OF THE DISCLOSURE

### Field of the Disclosure

The disclosure relates to a liquefied ammonia-ammonium composition, also referenced herein as a eurefstic composition. The composition includes ammonia; an ammonium cation, and a halogenated anion, and the composition is or remains in liquid form at a variety of ambient temperatures and pressures. The composition can be spontaneously formed by contacting gaseous ammonia or liquid ammonia with a solid halogenated ammonium salt. The composition can be later used to release ammonia or generate hydrogen gas.

### SUMMARY

In one aspect, the disclosure relates to a liquefied ammonia-ammonium composition (e.g., solution or eurefstic composition) comprising: ammonia (NH₃); an ammonium cation (NH₄⁺; as electrolyte); and a halogenated anion (as electrolyte/counter ion); wherein the composition is or remains in liquid form at ambient temperature and pressure. For example, the composition can be or remain in a liquid state at a 1 atm reference pressure and/or at 10, 15, 20, or 25° C. reference temperature, although in practice it can be stored and/or transported at any suitable temperature/pressure combination that maintains its liquid state. The reference pressure (e.g., 1 atm or otherwise) generally represents a gaseous ammonia atmosphere or headspace in a storage vessel, given the low partial pressure of ammonia in a typical air atmosphere that would otherwise result in release of ammonia gas over time from the liquefied composition. The halogenated anion generally includes at least one non-halogen atom and at least one halogen atom as a polyatomic anion, for example being represented by AXₙ^{-m} as described in more detail below, such as where A represents the non-halogen atom(s) and X represents the halogen atom(s).

Various refinements of the disclosed liquefied ammonia-ammonium composition are possible.

In a refinement, the halogenated anion is represented by (or comprises) AXₙ^{-m}, in which: A comprises, contains, or is one or more atoms from (i) Groups IIIA, IVA, VA, and/or VIA, and (ii) Periods 2 and 3 of the Periodic Table; X is one or more halogen atoms; n is 1 or more; and m is 1 or more. For example, A can include one or more of B, C, N, O, Al, Si, P, and S; preferably one or more of C, N, O, P, and S; and more preferably at least one of P and/or S and optionally at least one of C, N, and/or O. For example, X can be F, Cl, Br, I (preferably F), and it can include more than one type of halogen atom when n>1. For example, n can be 1 to 12 or 2 to 6, such as 1, 2, 3, 4, 5, 6, 7, 8, 9, 10, 11, or 12. For example m can be 1, 2, 3, 4, 5, or 6. In some embodiments, A can be represented by A′ₚ, where A′ includes one or more of B, C, N, O, Al, Si, P, and S as above for A, and p is 1 or more. For example, p can be 1 to 20 or 2 to 10, such as at least and/or up to 1, 2, 3, 4, 5, 6, 7, 8, 9, 10, 11, 12, 14, 16, 18, or 20.

In a refinement, the halogenated anion comprises CF₃SO₃⁻ (trifluoromethanesulfonate, triflate or OTf⁻). More generally, the halogenated anion can include a fluorinated hydrocarbon sulfonate, such as a sulfonate substituted with one or more carbon atoms having at least one fluorine substituent. For example, the halogenated anion can be represented by (CₙF₂ₙ₊₁₋ₘHₘ) SO₃⁻, where n is 1, 2, 3, or 4; and m is 0 to 2n, such as 0, 1, 2, 3, 4, 5, 6, 7, or 8.

In a refinement, the halogenated anion comprises PF₆⁻ (hexafluorophosphate).

In a refinement, the halogenated anion comprises at least one of P and S atoms (e.g., 1, 2, or 3 P atoms and/or 1, 2, or 3 S atoms); and the halogenated anion comprises at least one F atom.

In a refinement, the composition is free from non-halogenated anions (e.g., free from one or more of NO₃⁻ and SCN⁻).

In a refinement, the ammonium cation and the halogenated anion are present in the composition (e.g., liquid phase thereof) in an essentially stoichiometric ratio (e.g., on an equivalent or molar basis), such as with one component being within +/−0.1%, 1%, 2%, or 5% of its stoichiometric amount relative to the other component. For example, when the halogenated anion has a −1 charge, then the stoichiometric ratio is 1:1 for ammonium cation:halogenated anion in the liquid phase of the composition; when the halogenated anion has a −2 charge, then the stoichiometric ratio is 2:1 for ammonium cation:halogenated anion in the liquid phase of the composition, etc. The stoichiometric ratio can be other than whole number ratios, for example when a combination of two or more halogenated anions with different charges are included in the composition. Residual, non-converted halogenated ammonium salt (e.g., in solid form) is suitably not present in the composition, but can present in small amounts, such as a result of incomplete ammonia absorption and/or incomplete conversion to a eurefstic composition, incomplete solid/liquid separation to provide a final liquid phase/liquid form composition, etc. As described below, the ammonia and ammonium cation need not be present in a stoichiometric ratio.

In a refinement, the ammonia and the ammonium cation are present in the composition (e.g., liquid phase thereof) in a ratio of 0.6 to 5 (or 0.8 to 4, or 1 to 3) for ammonia relative to ammonium (e.g., on an equivalent or molar basis), such as at least 0.6, 0.8, 1, 1.2, 1.4, 1.6, 1.8, 2, 2.2, 2.5, or 3 and/or up to 1, 1.5, 2, 2.5, 3, 3.5, 4, 4.5, or 5. The foregoing ratios can be equivalently expressed as, e.g., 0.6:1 to 5:1 of ammonia:ammonium cation, etc.

In a refinement, the ammonia is present in the composition (e.g., liquid phase thereof) in an amount of 5 wt. % to 50 wt. % (or 8 wt. % to 40 wt. %, or 10 wt. % to 30 wt. %) relative to a combined amount of the ammonia, the ammonium cation, and the halogenated anion in the composition (e.g., liquid phase thereof). For example, the ammonia can be present in the composition in an amount of at least 5, 8, 10, 12, 15, 18, 20, or 25 wt. % and/or up to 10, 15, 20, 25, 30, 35, 40, 45, or 50 wt. %. The foregoing amounts and ranges can equivalently be expressed relative to the mass of the composition as a whole (e.g., if the composition contains other solid and/or liquid materials in admixture with the ammonia-ammonium cation-halogenated anion eurefstic composition).

In a refinement, the composition is a binary system (or solution) between (or comprising) (i) the ammonia and (ii) the ammonium cation and the halogenated anion collectively (e.g., as an electrolyte). Alternatively or additionally, a combined amount of the ammonia, the ammonium cation, and the halogenated anion can be at least 95, 97, 98, 99, 99.5, 99.8, or 99.9 wt. % and/or up to 98, 99, or 100 wt. % of the composition. Similarly, the composition can contain up to (or not more than) 0.001, 0.01, 0.1, 0.2, 0.5, 1, 2, 3, or 5 wt. % of components other than the ammonia, the ammonium cation, and the halogenated anion.

In a refinement, the composition is in liquid form at 1 atm and 20° C. More generally, the composition can be or otherwise remain in a liquid form or state at a 1 atm reference pressure (absolute) and at 10, 15, 20, 25, 30, 40, 50, 60, or 70° C. reference temperature. The reference pressure can reflect a gaseous ammonia atmosphere (e.g., containing essentially only ammonia or at least 95, 98, or 99 mol. % ammonia) having a pressure of 1 atm, or a gaseous atmosphere having a partial pressure of ammonia of 1 atm.

In a refinement, the composition has a vapor pressure of 1 atm or about 1 atm at 20° C.

In another aspect, the disclosure relates more generally to a liquefied ammonia-cation composition (e.g., solution or eurefstic composition) comprising: ammonia (NH₃); at least one cation selected from the group consisting of an ammonium cation, a lithium cation, a sodium cation, another alkali metal cation, and combinations thereof (e.g., one or more of NH₄⁺, Li⁺, and Na⁺; as electrolyte); and a halogenated anion (as electrolyte/counter ion); wherein the composition is or remains in liquid form at ambient temperature and pressure. Solid halogenated salts of alkali metals such as lithium and sodium also can form liquefied ammonia-cation compositions analogous to the liquefied ammonia-ammonium compositions described herein. The various aspects, embodiments, refinements herein described for the liquefied ammonia-ammonium composition can apply as well to the liquefied ammonia-cation composition more generally, references to ammonium cations can apply more generally to alkali metal cations alone or in combination with ammonium cations (e.g., when more than one ammonium, lithium, or sodium halogenated salt is used to form the liquefied composition), references to halogenated ammonium salts can apply more generally to halogenated alkali metal salts alone or in combination with halogenated ammonium salts, etc.

In another aspect, the disclosure relates to a method for making a liquefied ammonia-ammonium composition (or liquefied ammonia-cation composition), the method comprising: contacting (i) a solid halogenated ammonium salt (e.g., one, two, or more solid halogenated ammonium salts) with (ii) gaseous ammonia to form a liquid product, such as by contacting at ambient temperature/pressure conditions, or liquid ammonia to form a liquid product, such as by contacting at low temperature conditions. The liquid product can comprise the liquefied ammonia-ammonium composition according to any of its variously disclosed embodiments, refinements, etc.

Various refinements of the disclosed method for making a liquefied ammonia-ammonium composition are possible.

In a refinement, the solid halogenated ammonium salt comprises (NH₄⁺)ₘ(AXₙ^{-m}), in which: A is one or more atoms from (i) Groups IIIA, IVA, VA, and/or VIA, and (ii) Periods 2 and 3 of the Periodic Table; X is one or more halogen atom; n is 1 or more; and m is 1 or more. The various options for A, X, n, and m are as described above.

In a refinement, the solid halogenated ammonium salt comprises NH₄CF₃SO₃ (ammonium triflate or NH₄OTf). More generally, the solid halogenated ammonium salt can include an ammonium salt with a fluorinated hydrocarbon sulfonate as described above.

In a refinement, the solid halogenated ammonium salt comprises NH₄PF₆ (ammonium hexafluorophosphate).

In a refinement, the method comprises contacting the solid halogenated ammonium salt with an amount of ammonia in a ratio of 0.6 to 5 (or 0.8 to 4, or 1 to 3) for ammonia relative to the ammonium content of the solid halogenated ammonium salt (e.g., on an equivalent or molar basis). The ratio more generally can be at least 0.6, 0.8, 1, 1.2, 1.4, 1.6, 1.8, 2, 2.2, 2.5, or 3 and/or up to 1, 1.5, 2, 2.5, 3, 3.5, 4, 4.5, or 5. The foregoing ratios can be equivalently expressed as, e.g., 0.6:1 to 5:1 of ammonia:ammonium content of the salt, etc.

In a refinement, the method comprises contacting the solid halogenated ammonium salt with the ammonia at (i) a temperature in a range from −80° C. to 60° C. (or −50° C. to 50° C., or −30° C. to 30° C.), and (ii) a pressure in a range from 0.2 atm to 5 atm (or 0.5 atm to 2 atm, or 0.8 atm to 1.2 atm). For example, the preparation or contacting temperature can be as low as about −80° C. with the ammonia in liquid form and the solid halogenated ammonium salt becomes dissolved or admixed therein, and the corresponding liquefied composition forms when the mixture is brought to an ambient temperature and/or pressure. In other cases, the preparation or contacting temperature can be as low as about −30° C. (e.g., at 1 atm) with the ammonia in gaseous form, and the corresponding liquefied composition forms (e.g., spontaneously) when the gaseous ammonia contacts the solid halogenated ammonium salt. More generally, the temperature can be at least −80, −70, −60, −50, −40, −30, −20, −10, 0, 5, 10, 15, 20, or 25° C. and/or up to −40, −30, −20, −10, 0, 5, 10, 15, 20, 25, 30, 35, 40, 50, or 60° C. Alternatively or additionally, the pressure can be at least 0.2, 0.5, 0.7, 0.8, 0.9, 0.95, 1, 1.05, 1.1, or 1.2 atm and/or up to 0.95, 1, 1.05, 1.1, 1.2, 1.5, 2, 2.5, 3, 4, or 5 atm (absolute). The foregoing pressures can independently represent total pressure and/or ammonia partial pressure.

In a further refinement, the ammonia comprises the gaseous ammonia, and the temperature is in a range from −30° C. to 60° C., for example at any of the temperature sub-ranges above and/or at any of the pressure ranges or sub-ranges above.

In a further refinement, the ammonia comprises the liquid ammonia, and the temperature is in a range from −80° C. to −30° C., for example at any of the temperature sub-ranges above and/or at any of the pressure ranges or sub-ranges above.

In a refinement, substantially only the ammonia and one or more solid halogenated ammonium salts are contacted to form the liquid product. For example, the ammonia and/or solid halogenated ammonium salt feeds to the absorption vessel or other process vessel contain up to (or not more than) 0.001, 0.01, 0.1, 0.2, 0.5, 1, 2, 3, or 5 wt. % of components other than the ammonia and/or solid halogenated ammonium salts.

In another aspect, the disclosure relates to a method for forming ammonia, the method comprising: subjecting the liquefied ammonia-ammonium composition (or liquefied ammonia-cation composition) according to any of its variously disclosed embodiments, refinements, etc. to temperature and pressure conditions sufficient to liberate gaseous ammonia from the composition. The selected temperature and pressure conditions are not particularly limited, but can include heating and/or subjecting to a reduced pressure (or vacuum) the liquefied ammonia-ammonium composition (e.g., relative to ambient conditions). For example, the temperature can be at least 20, 25, 30, or 35° C. and/or up to 30, 35, 40, 50, or 60° C. Alternatively or additionally, the pressure can be at least 0.00001, 0.0001, 0.001, 0.01, 0.1, 0.2, 0.5, 0.7, 0.8, 0.9, or 0.95 atm and/or up to 0.0001, 0.001, 0.01, 0.1, 0.2, 0.4, 0.7, 0.9, 0.95, 1, 1.05, 1.1, 1.2 atm (absolute).

Various refinements of the disclosed method for forming ammonia are possible.

In a refinement, the method further comprises recovering a solid halogenated ammonium salt after liberating the gaseous ammonia, the solid halogenated ammonium salt comprising a salt between the ammonium cation and the halogenated anion of the liquefied ammonia-ammonium composition; and optionally contacting the recovered solid halogenated ammonium salt with gaseous ammonia to form a new liquid product. The new liquid product can represent a regenerated liquefied ammonia-ammonium composition, for example after transporting the recovered solid halogenated ammonium salt to the same or different facility where the original liquefied ammonia-ammonium composition was formed. In some embodiments, the liquefied ammonia-ammonium composition remains in liquid form even after partial liberation of some ammonia therefrom (albeit with a correspondingly lower ammonia content), because the liquefied ammonia-ammonium composition can be formed and remain in a liquid state over a range of different ammonia contents. For example, the ammonia remaining in the liquefied composition after partial ammonia liberation therefrom can generally be within the broad ranges and sub-ranges described above for the liquefied composition, such as a ratio of 0.6 to 5 for the ammonia:ammonium cation ratio and/or an amount of 5 wt. % to 50 wt. % for ammonia relative to a combined amount of ammonia, ammonium cation, and halogenated anion. Such residual or remaining liquefied ammonia-ammonium composition can then be used at a later time to generate more ammonia gas as needed.

In a refinement, the method further comprises transporting the liquefied ammonia-ammonium composition in liquid form from its original production facility to a different location for ammonia generation, prior to subjecting the liquefied ammonia-ammonium composition to the temperature and pressure conditions sufficient to liberate the gaseous ammonia from the composition.

In another aspect, the disclosure relates to a method for forming hydrogen, the method comprising: electrolyzing the liquefied ammonia-ammonium composition (or liquefied ammonia-cation composition) according to any of its variously disclosed embodiments, refinements, etc. to form and liberate gaseous hydrogen (H₂) from the composition. The electrolysis method generally will form gaseous nitrogen (N₂) as a result of ammonia oxidation in addition to the gaseous hydrogen (H₂) from ammonium reduction (e.g., in a stoichiometric ratio of 3:1 H₂:N₂). The two gaseous products can be produced as separate gases (e.g., using a divided electrochemical cell for electrolysis) or as a gaseous mixture (e.g., using a single or undivided electrochemical cell for electrolysis). The electrolytic conditions are not particularly limited, and can include suitable selections for electrodes, operating potentials or voltages, operating currents, etc., as generally known to the skilled artisan.

Various refinements of the disclosed method for forming hydrogen gas are possible.

In a refinement, the method further comprises recovering a solid halogenated ammonium salt after liberating and forming the gaseous hydrogen, the solid halogenated ammonium salt comprising a salt between the ammonium cation and the halogenated anion of the liquefied ammonia-ammonium composition; and optionally contacting the recovered solid halogenated ammonium salt with gaseous ammonia to form a new liquid product. The new liquid product can represent a regenerated liquefied ammonia-ammonium composition, for example after transporting the recovered solid halogenated ammonium salt to the same or different facility where the original liquefied ammonia-ammonium composition was formed. In some embodiments, the liquefied ammonia-ammonium composition remains in liquid form even after formation and liberation of some hydrogen gas therefrom (albeit with a correspondingly lower ammonia content), because the liquefied ammonia-ammonium composition can be formed and remain in a liquid state over a range of different ammonia contents. Such residual or remaining liquefied ammonia-ammonium composition can then be used at a later time to generate more hydrogen gas as needed.

While the disclosed compositions and methods are susceptible of embodiments in various forms, specific embodiments of the disclosure are illustrated (and will hereafter be described) with the understanding that the disclosure is intended to be illustrative, and is not intended to limit the claims to the specific embodiments described and illustrated herein.

### BRIEF DESCRIPTION OF THE DRAWINGS

FIG. 1 shows a schematic of the synthesis of an ammonia/ammonium composition according to the disclosure and a schematic of the formation of hydrogen and nitrogen via electrolysis of an ammonia/ammonium composition according to methods of the disclosure.

FIG. 2 shows a schematic of releasing ammonia from an ammonia/ammonium composition according to the disclosure.

FIG. 3 shows graphs of density as a function of ammonia content for ammonia/ammonium triflate and ammonia/ammonium hexafluorophosphate eurefstics.

FIG. 4 shows graphs of ammonia content as a function of temperature for ammonia/ammonium triflate and ammonia/ammonium hexafluorophosphate eurefstics.

FIG. 5 shows cyclic voltammetry (CV) and open circuit potential (OCP) plots for ammonia/ammonium triflate and ammonia/ammonium hexafluorophosphate eurefstics.

### DETAILED DESCRIPTION

The disclosure relates to a liquefied ammonia-ammonium composition, also referenced herein as a eurefstic composition or a eurefstic. The composition includes ammonia, an ammonium cation, and a halogenated anion. The ammonium cation and halogenated anion can be provided, for example, as a halogenated ammonium salt. In general, the composition is a liquid or remains in liquid form at ambient temperatures and pressures or ranges encompassing the same.

The disclosure also relates to methods of making a liquified ammonia-ammonium composition according to the disclosure. The composition of the disclosure can be formed by contacting gaseous or liquid ammonia with a solid halogenated ammonium salt, such as ammonium triflate or ammonium hexafluorophosphate, wherein the solid halogenated ammonium salt absorbs the ammonia to form the liquid eurefstic composition (i.e., the eurefstic composition). The eurefstic composition can provide a convenient, safe, and ammonia-dense liquid that is easily transportable and safely storable until later use, for example to release and generate ammonia, or to generate hydrogen gas via electrolysis. The ammonia or hydrogen gas thus produced can then be used as a combustion fuel or other energy source.

Also disclosed herein are methods of forming ammonia, comprising subjecting a liquefied ammonia-ammonium composition according to the disclosure to temperature and pressure conditions sufficient to liberate gaseous ammonia.

Also disclosed herein are methods of forming hydrogen, comprising electrolyzing a liquefied ammonia-ammonium composition according to the disclosure to form and liberate gaseous hydrogen.

### Eurefstic Compositions

In general, the eurefstic compositions described herein are binary solutions, containing ammonia and an ammonium salt, or ammonia and a salt of another cation. “Eurefstic” as used herein generally refers to a liquid formed by mixing a solid and gas at standard conditions (i.e., about room temperature and atmospheric pressure). (This term is introduced to differentiate from the phenomenon of deliquescence, that is, liquefaction of a substance via absorption of water vapor.)

As disclosed herein, two particular ammonia/ammonium eurefstics, containing ammonium triflate (NH₄OTf) or ammonium hexafluorosphosphate (NH₄PF₆) as the ammonium salt, can provide safe and efficient means for storing, transporting, and releasing ammonia at ambient temperatures and pressures.

### Methods of Preparing Eurefstic Compositions

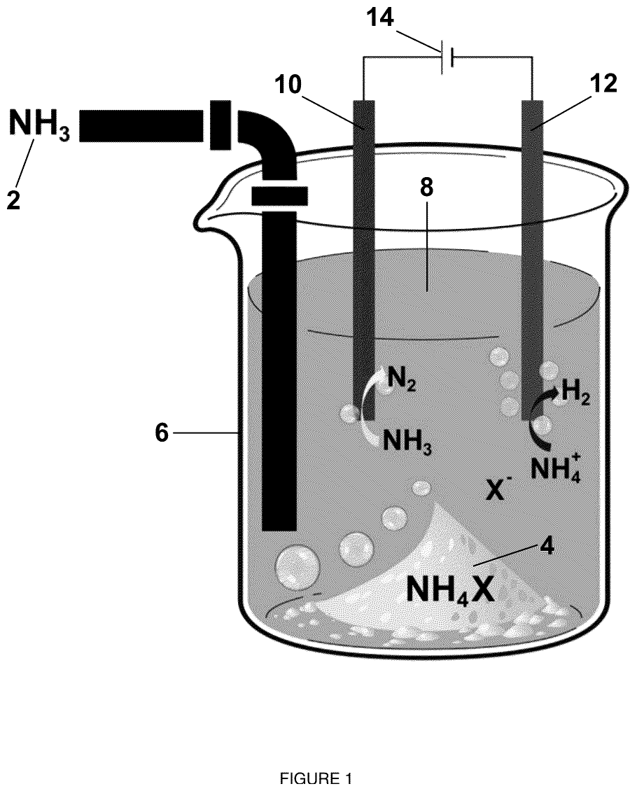

In general, the eurefstic compositions can be prepared by passing ammonia over a sample of an ammonium salt or other salt, so as to form a liquid composition comprising ammonia and the ammonium salt or other salt. FIG. 1 shows a general schematic of the preparation of an ammonia/ammonium eurefstic. Ammonia 2 (NH₃ as illustrated, for example in gaseous or liquid form) is contacted with an ammonium salt 4 (NH₄X as illustrated) in a vessel 6 to generate a eurefstic composition 8. The eurefstic composition 8 is a liquid and can be, for instance, a colorless transparent liquid. (X⁻ in FIG. 1 denotes the anion comprising the ammonium salt (for instance, triflate or PF₆⁻) and does not necessarily represent a halogen atom.) While FIG. 1 shows an open vessel, the step of adding ammonia to the ammonium salt or other salt is preferably performed in a sealed vessel, as described in further detail herein.

During their preparation, the eurefstics typically reached phase equilibrium with gaseous ammonia within 5-30 min. In general, this ammonia-absorbing, or “ammonoscopic,” process was exothermic and occurred spontaneously at room temperature.

In general, the eurefstics can be stored at room temperature in a sealed vessel for weeks without apparent changes. When stored in an open container, the eurefstic can release ammonia, as indicated by its mass reducing over time, though the eurefstic can remain a liquid over tens of hours. The eurefstic can generally be transferred using standard pipetting techniques, similar to other volatile liquids.

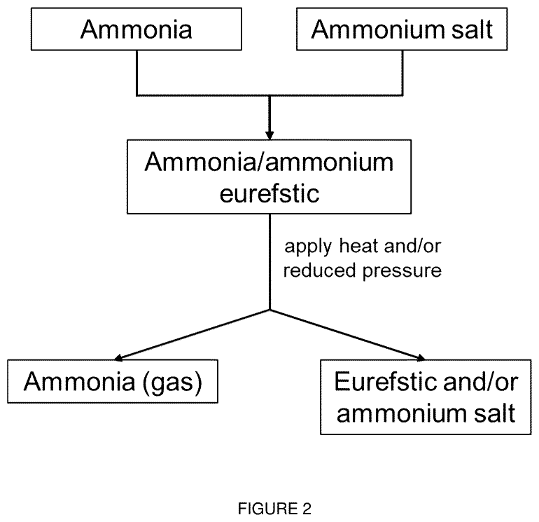

Ammonia can be released from the eurefstics by applying heat and/or reduced pressure. FIG. 2 shows a flow diagram of the release of ammonia gas from a eurefstic, including preparing the eurefstic from ammonia and an ammonium salt and applying heat and/or reduced pressure to release ammonia gas. The release of ammonia can include release of some, or all, of the ammonia comprising the eurefstic; the material remaining after ammonia release can include the ammonium salt, or a eurefstic containing less ammonia than the starting eurefstic, or a combination thereof.

Generally, the process of storing and releasing ammonia from the eurefstics can be reversible: adding ammonia to the solid ammonium salts that remain after releasing the ammonia (i.e., by heating or pulling vacuum) can regenerate the eurefstic.

### Electrochemical Properties

The eurefstics disclosed herein are binary systems, containing a conjugate acid (ammonium) and base (ammonia). The high concentration of ammonium salt can effectively act as a supporting electrolyte, and the ammonia eurefstics can accordingly be directly used as electrochemical substrates. In this regard, eurefstics can be considered similar to room temperature ionic liquids (RTILs). For example, the conductivity of a NH₃/NH₄OTf eurefstic was measured to be about 10⁻¹ S/cm, comparable with that of other electrolytes based on RTILs and their mixtures (typically on the order of 10⁻² to 10° S/cm). Furthermore, these eurefstics can contain much higher concentrations of ammonia (for instance, about 14 mol/L of ammonia with NH₄OTf and about 17 mol/L of ammonia with NH₄PF₆; more generally at least 10, 12, 14, or 16 mol/L and/or up to 15, 17, 20, 22, or 25 mol/L of ammonia) compared to commonly used nonaqueous binary electrolytes that contain ammonia and an ammonium salt (for example, solutions of acetonitrile or tetrahydrofuran (THF)). The high ammonia content of the eurefstic compositions can potentially enable electrocatalytic ammonia splitting reactions to be performed with increased efficiency.

To demonstrate the potential of ammonia eurefstics as electrolytes for electrochemical ammonia splitting reactions, such as for hydrogen generation, cyclic voltammetry (CV) measurements were carried out according to methods described herein. FIG. 1 shows a schematic of an ammonia splitting reaction using an ammonia/ammonium eurefstic as the ammonia source, wherein the eurefstic 8 is used as an electrochemical substrate, and an anode 10, cathode 12, and power supply 14 are components of the electrochemical system. Ammonia oxidation to form nitrogen occurs at the anode 10, and hydrogen evolution reaction to form hydrogen from ammonium occurs at the cathode 12.

### Materials

Anhydrous ammonia and anhydrous hydrogen were obtained from a commercial source. The ammonia was dried prior to use as follows. The gaseous ammonia was condensed in a Schlenk flask containing sodium metal using a dry ice/ethanol bath, and a deep blue colored liquid (indicative of solvated electrons in liquid ammonia) was formed. The Schlenk flask was brought to a higher temperature to begin boiling the liquid ammonia, and dry ammonia gas was transferred out as needed. Dry ammonia can also be obtained by passing ammonia through a drying column filled with calcium oxide. Silver nitrate (99.9+ %) was obtained from a commercial source and used as received. Ammonium hexafluorophosphate (NH₄PF₆^{,} 99.5%) was obtained from a commercial source and was washed with tetrahydrofuran (THF) and vacuum-dried at 80° C. for 12 h prior to use. Tetrabutylammonium hexafluorophosphate (Bu₄NPF₆, 98%) was obtained from a commercial source and recrystallized twice from ethanol prior to use. Trifluoromethanesulfonic acid (triflic acid, 99.5%) was obtained from a commercial source and used as received. Phosphorous pentoxide (P₂O₅, 98%) was obtained from a commercial source and used as received. THF, ethanol, and dichloromethane (DCM) were obtained from commercial sources and used as received. Acetonitrile was obtained from a commercial source, dried through an alumina column, and distilled from P₂O₅ prior to use.

Ammonium triflate (NH₄OTf) was synthesized by bubbling dry ammonia to a solution of triflic acid in THF (˜1 M) in a dry ice-ethanol bath, with vigorous stirring under a nitrogen atmosphere. A glass inlet was used in order to avoid corrosion of metal parts by triflic acid. The temperature was maintained at about −40° C. to minimize undesirable side reactions. The reaction was monitored using pH paper strips and was carried out until the reaction solution became basic. Then nitrogen was bubbled through the reaction solution to remove excess ammonia, followed by removal of the solvent THF under reduced pressure, yielding a white solid product. The crude product was recrystallized from THF:DCM (1:2 volume ratio). The final product was vacuum-filtered, washed with 3 aliquots of DCM to yield a white powder, and sealed in a flask and dried under high vacuum (<10 Pa) overnight. The dried product was characterized using 1H and 19F NMR spectroscopy and IR spectroscopy.

Ammonium hexafluorophosphate was commercially available and was used after recrystallization and vacuum drying according to the same method used for ammonium triflate.

### Test Methods

### Measuring Physical Properties of Eurefstics

The density of a eurefstic was determined by dividing the mass of a sample of the eurefstic by its volume. Mass was determined by mass difference. A graduated, volumetric vessel containing a stir bar and fitted with a septum was weighed. A sample of about 3 mL of eurefstic was added to the vessel, and the vessel was sealed and weighed. The difference in mass was taken as the mass of the eurefstic. The volume of the same sample of eurefstic was read directly from the graduation on the vessel, and corrected to account for the volume of the stir bar.

To vary the composition of a eurefstic, dry nitrogen was blown into a vessel containing the eurefstic, above the liquid, to reduce its ammonia content, while stirring the eurefstic and mildly heating the vessel to ensure the homogeneity of the sample. Periodically, the vessel was sealed, cooled to room temperature and weighed again. This process was repeated until the sample solidified. The composition was calculated from the total mass of the sample and the initial mass of the ammonium salt, and the density of each intermediate composition was taken as the ratio of mass to volume. Temperature-dependent composition measurements were also performed.

### Electrochemical Measurements

Cyclic voltammetry (CV) measurements were carried out using a Pt disk working electrode, a glassy carbon counter electrode, and a double-junction Ag^{0/+} reference electrode. In general, three CV scans were performed on each sample to be studied, scanning negatively from 0 V vs. Ag^{0/+} at 100 mV/s. Open-circuit potential (OCP) measurements were carried out in the same cells in which CV measurements were carried out, between the Pt working electrode and the same Ag^{0/+} double-junction reference electrode while bubbling H₂ through the electrolyte onto the Pt electrode.

### EXAMPLES

The following examples illustrate the compositions and methods according to the disclosure.

### Example 1: Preparation of Ammonia/Ammonium Triflate (NH₃/NH₄OTf) Eurefstic

10 g of NH₄OTf was added to a tared Schlenk flask containing a stir bar. Dry ammonia gas was introduced to the flask and flowed over the solid while stirring to refresh the contact surface between the solid and the gas phase. The entire system was closed, and the exhaust was directed to a bubbler to prevent air and water entering the system. Within 10 min the NH₄OTf powder had absorbed ammonia gas and formed a colorless transparent liquid. The temperature of the flask increased as the reaction proceeded. After complete eurefstification and cooling of the reaction mixture to room temperature, the Schlenk flask was sealed and disconnected from the setup. The flask and its contents were weighed, and the mass difference before and after the reaction was taken to determine the amount of ammonia absorbed.

### Example 2: Preparation of Ammonia/Ammonium Hexafluorophosphate (NH₃/NH₄PF₆) Eurefstic

Preparation of a NH₃/NH₄PF₆ eurefstic was carried out according to a method similar to that used to prepare the NH₃/NH₄OTf eurefstic of Example 1, using ammonium hexafluorophosphate in place of ammonium triflate. Ammonia and ammonium hexafluorophosphate were contacted for 30 min with stirring to achieve complete eurefstification.

Passing ammonia gas at 1 atm pressure over NH₄OTf at 20° C. resulted in the uptake of 2 equivalents of ammonia to form a transparent colorless eurefstic. When NH₄PF₆ was used as the salt, 3 equivalents of ammonia were absorbed in generating the eurefstic. In part as a consequence of carrying out the syntheses under atmospheric pressure, the ammonia eurefstic has a vapor pressure of about 1 atm, according to the definition of phase equilibrium; this is significantly lower than the vapor pressure of pure liquid ammonia at 20° C. (8.5 atm).

The preparation method of Example 1 was carried out for Examples 3-12 using other ammonium salts in place of ammonium triflate, to test whether ammonium salts could form eurefstic compositions with ammonia. Results are shown in Table 1, in which ammonium salts are listed according to their counterion. The amount of ammonia that could be absorbed by each salt was determined by mass difference and is expressed as molar equivalents of ammonia based on the amount of salt.

TABLE 1
Eurefstification of Ammonium Salts with
Ammonia at Ambient Conditions

| | Ammonium | Equivalents of | NH₃ stored |
|---|---|---|---|
| | Salt | NH₃ absorbed | (mass % of |
| Example | Counterion | at 25° C. | composition) |
| 1 | Triflate | 2 | 18.7% |
| 2 | PF₆⁻ | 3 | 23.1% |
| 3 | NO₃⁻ | 1.2 | 25.0% |
| 4 | SCN⁻ | 2 | 31.6% |
| 5 | BF₄⁻ | 0.1 | No eurefstic formed |
| 6 | BPh₄⁻ | 1.7 | No eurefstic formed |
| 7 | C₄F₉SO₃⁻ | 0.4 | No eurefstic formed |
| 8 | Acetate | 0 | No eurefstic formed |
| 9 | Br⁻ | 0 | No eurefstic formed |
| 10 | Cl⁻ | 0 | No eurefstic formed |
| 11 | SO₄²⁻ | 0 | No eurefstic formed |
| 12 | SbF₆⁻ | 0 | No eurefstic formed |

As seen in Table 1, not all ammonium salts formed eurefstic compositions. Furthermore, several salts absorbed a measurable amount of ammonia but did not form a eurefstic composition (i.e., the salts absorbed ammonia but did not form a homogeneous liquid composition). For instance, ammonium tetraphenylborate (NH₄BPh₄) absorbed 1.7 molar equivalents of ammonia but did not form a eurefstic composition. Accordingly, a salt's capacity to absorb ammonia was not a sufficient indicator of whether the salt could form a eurefstic composition with ammonia.

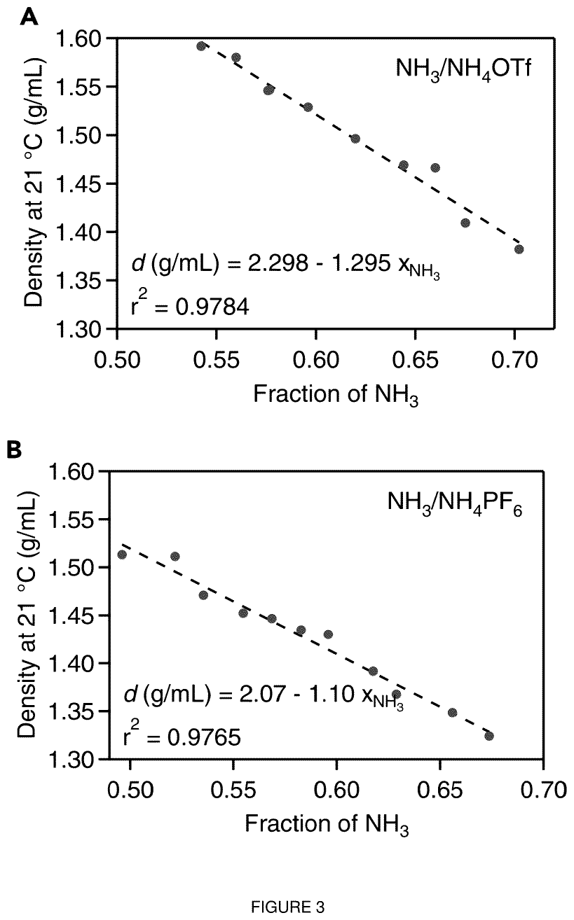

The whole number or near whole number mole ratios between ammonia and ammonium salts in some of the eurefstics could suggest that these are stoichiometric compositions. Further experiments were carried out to assess the composition of the eurefstics. FIG. 3 shows the densities of several NH₃/NH₄OTf (panel A) and NH₃/NH₄PF₆ (panel B) eurefstics as a function of ammonia content. FIG. 3 indicates that the eurefstics can exist as a liquid phase over a range of compositions (i.e., a range of ammonia:salt ratios), rather than only at stoichiometric compositions. Stoichiometric compositions for the eurefstics at maximum ammonia absorption could indicate a well-defined composition, as has been observed for certain ionic liquids and fused salts. However, without intending to be bound by theory, it is believed that the maintaining of a eurefstic state at lower, nonstoichiometric ratios distinguishes the eurefstics from ionic liquids or other discrete ammonia compounds. It is further believed that hydrogen bonding interactions between cations and ammonia, and/or between anions and ammonia, contribute to preserving the eurefstic compositions in a liquid state at temperatures far above the boiling point of ammonia. Accordingly, the eurefstic compositions can also be considered distinct from solvent/solute systems, at least because there is generally insufficient excess concentration of a species to form solvent shells, which are present in the least ideal of solutions.

Since the eurefstics are mixtures, their physical properties can be composition dependent. For example, FIG. 3 shows that the density of NH₃/NH₄OTf and NH₃/NH₄PF₆ eurefstics changed linearly with ammonia content and also depended on the choice of anion. In general, densities of NH₃/NH₄OTf eurefstics were greater than densities of NH₃/NH₄PF₆ having the same fraction of ammonia content.

### Temperature Dependence

The dependence of eurefstic composition and physical state on temperature was studied by preparing eurefstics using liquid ammonia and adjusting temperature in a controlled manner. Samples were prepared in a Schlenk (air-free) flask mounted with a dry ice-cooled condenser. Ammonia was condensed dropwise and directly to a preweighed amount of ammonium salt (NH₄OTf or NH₄PF₆) with vigorous stirring, until ammonia was in excess. The condenser was then replaced with a rubber septum to seal the system, and a branch tube was connected to a fume hood through a mineral oil bubbler. The ammonia partial pressure inside the Schlenk flask thus remained at 1 atm; accordingly, the eurefstic compositions have a vapor pressure of 1 atm when reaching equilibrium with the gas phase. The Schlenk flask was submerged in a water/ice bath, and the temperature was varied from 0° C. to 80° C. with mild stirring. The rate of temperature increase was controlled at approximately 1° C./min to allow phase equilibrium to be reached. During the process of increasing temperature, ammonia was continuously released from the eurefstic. The rate of release was approximately 1 mL/min for a 15 g sample of eurefstic, and the liquid phase was assumed to be in equilibrium with the gas phase.

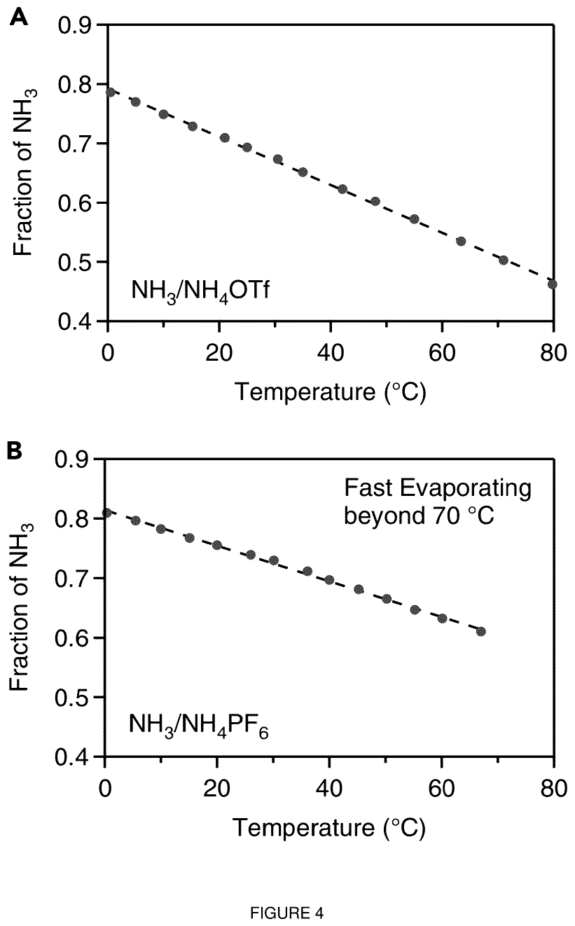

The composition of the liquid during ammonia release was monitored by measuring the total mass of the liquid. FIG. 4 shows plots of the compositions of NH₄OTf (panel A) and NH₄PF₆ (panel B) eurefstics, expressed as ammonia content as a weight fraction of the total sample weight, as a function of temperature. For the NH₃/NH₄OTf eurefstic, ammonia release was relatively slow up to 80° C. For the NH₃/NH₄PF₆ eurefstic, ammonia release was relatively slow up to about 70° C., and at higher temperatures the solution effervesced vigorously accompanied by formation of a white precipitate. FIG. 4 indicates that the change in ammonia content was relatively continuous over a wide temperature range.

Fluorine NMR spectra of NH₃/NH₄OTf eurefstics with varied composition (data not shown) indicated a composition dependence of the chemical shift of the triflate peak. Without intending to be bound by theory, it is believed this dependence could result from composition-dependent changes in hydrogen bonding interactions or solvation effects.

### Electrochemical Studies

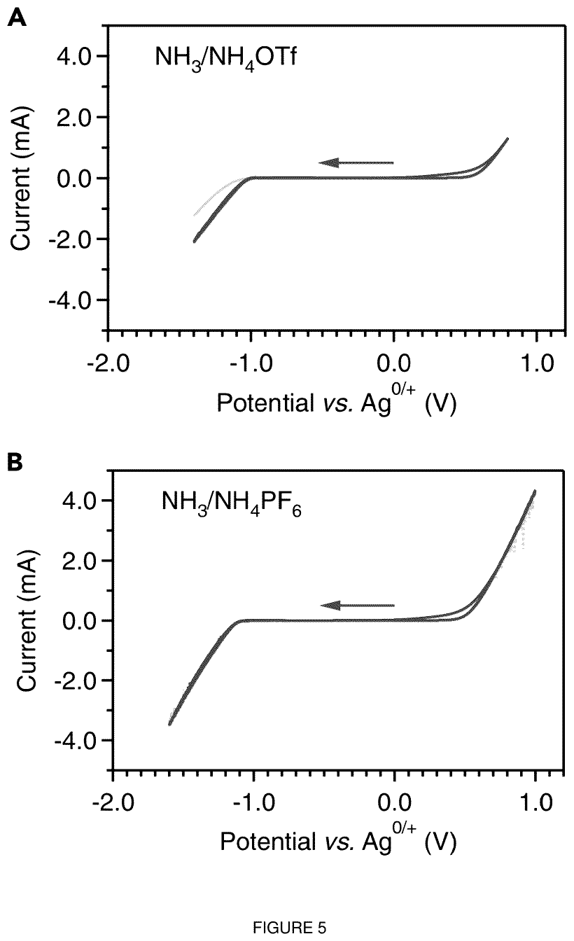

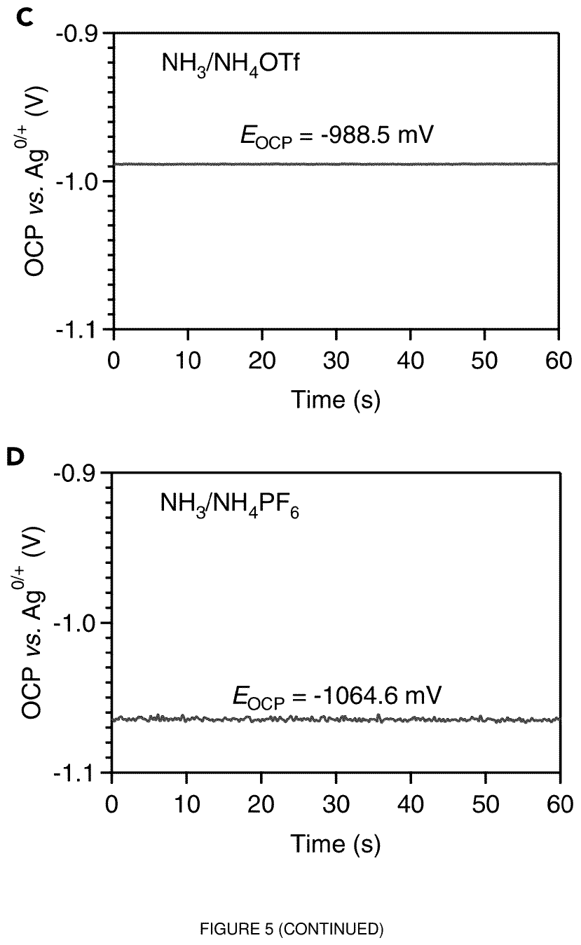

FIG. 5 shows the results of three CV scans performed on samples of NH₄OTf (panel A) and NH₄PF₆ (panel B) eurefstics. The shape and onset potentials for the oxidation and reduction waves for the two different eurefstics are very similar, indicating that the electrochemical responses are effectively anion independent. The anodic and cathodic currents are assigned to ammonia oxidation and hydrogen evolution reaction (HER), respectively.

The ammonia eurefstics can be used for electrolytic generation of hydrogen.

Without intending to be bound by theory, it is believed that eurefstics containing ammonium triflate or ammonium hexafluorophosphate can provide advantages for electrolytic generation of hydrogen. In particular, triflate and PF₆-anions are electrochemically inert, and NH₄⁺ is a useful proton source for the hydrogen evolution reaction (it is more favorable to solvate an electron than to reduce liquid NH₃ without NH₄⁺). In comparison, SCN⁻ can be susceptible to competitive oxidation, and use of other cations, e.g., Na⁺, will not result in hydrogen evolution.

FIG. 5 shows the results of OCP measurements on samples of NH₄OTf (panel C) and NH₄PF₆ (panel D) eurefstics. OCP, as a zero-current potentiometric method, directly measures the thermodynamic potential of HER under the same conditions of the cell. Compared with the onset of the ammonium reduction wave observed on the CVs, the OCP data show that there is a minimal overpotential for the HER in this system. This small overpotential is consistent with HER on Pt electrodes. The 1.5 V potential window indicated by the CVs, however, is well beyond the thermodynamic potential needed for ammonia splitting reaction (˜0.1 V versus the thermodynamic hydrogen evolution potential), suggesting that there is a large kinetic overpotential associated with ammonia oxidation in this electrolyte on the Pt electrode surface, leaving much room for catalysts development in these eurefstics. With the assumption that the Ag^{0/+} reference electrode has the same potentiometric behavior in the eurefstics reported herein and in liquid ammonia (at −40° C., account for the potential change of 26 mV due to the temperature difference), the cathodic and anodic onset potentials of eurefstics are very similar to that of liquid ammonia.

Because other modifications and changes varied to fit particular operating requirements and environments will be apparent to those skilled in the art, the disclosure is not considered limited to the example chosen for purposes of illustration, and covers all changes and modifications which do not constitute departures from the true spirit and scope of this disclosure.

Accordingly, the foregoing description is given for clearness of understanding only, and no unnecessary limitations should be understood therefrom, as modifications within the scope of the disclosure may be apparent to those having ordinary skill in the art.

All patents, patent applications, government publications, government regulations, and literature references cited in this specification are hereby incorporated herein by reference in their entirety. In case of conflict, the present description, including definitions, will control.

Throughout the specification, where the compositions, processes, kits, or apparatus are described as including components, steps, or materials, it is contemplated that the compositions, processes, or apparatus can also comprise, consist essentially of, or consist of, any combination of the recited components or materials, unless described otherwise. Component concentrations can be expressed in terms of weight concentrations, unless specifically indicated otherwise. Combinations of components are contemplated to include homogeneous and/or heterogeneous mixtures, as would be understood by a person of ordinary skill in the art in view of the foregoing disclosure.

What is claimed is:

1. A liquefied ammonia-ammonium composition comprising:
ammonia;
an ammonium cation; and
a halogenated anion;
wherein the composition is in liquid form at ambient temperature and pressure.

2. The composition of claim 1, wherein the halogenated anion is represented by AXₙ^{-m}, in which:
A comprises one or more atoms from (i) Groups IIIA, IVA, VA, and/or VIA, and (ii) Periods 2 and 3 of the Periodic Table;
X is one or more halogen atoms;
n is 1 or more; and
m is 1 or more.

3. The composition of claim 1, wherein the halogenated anion comprises CF₃SO₃⁻ (trifluoromethanesulfonate, triflate or OTf⁻).

4. The composition of claim 1, wherein the halogenated anion comprises PF₆⁻ (hexafluorophosphate).

5. The composition of claim 1, wherein:
the halogenated anion comprises at least one of P and S atoms; and
the halogenated anion comprises at least one F atom.

6. The composition of claim 1, wherein the composition is free from non-halogenated anions.

7. The composition of claim 1, wherein the ammonium cation and the halogenated anion are present in the composition in an essentially stoichiometric ratio.

8. The composition of claim 1, wherein the ammonia and the ammonium cation are present in the composition in a ratio of 0.6 to 5 for ammonia relative to ammonium.

9. The composition of claim 1, wherein the ammonia is present in the composition in an amount of 5 wt. % to 50 wt. % relative to a combined amount of the ammonia, the ammonium cation, and the halogenated anion in the composition.

10. The composition of claim 1, wherein the composition is a binary system between (i) the ammonia and (ii) the ammonium cation and the halogenated anion collectively.

11. The composition of claim 1, wherein the composition is in liquid form at 1 atm and 20° C.

12. The composition of claim 1, wherein the composition has a vapor pressure of 1 atm at 20° C.

13. A liquefied ammonia-cation composition comprising:
ammonia;
at least one cation selected from the group consisting of an ammonium cation, a lithium cation, a sodium cation, and combinations thereof; and
a halogenated anion;
wherein the composition is in liquid form at ambient temperature and pressure.

14. A method for making a liquefied ammonia-ammonium composition, the method comprising:
contacting (i) a solid halogenated ammonium salt with (ii) at least one of gaseous ammonia and liquid ammonia to form a liquid product.

15. The method of claim 14, wherein the solid halogenated ammonium salt comprises a salt between an ammonium cation and a halogenated anion.

16. The method of claim 14, wherein the solid halogenated ammonium salt comprises (NH₄⁺)ₘ(AXₙ^{-m}), in which:
A comprises one or more atoms from (i) Groups IIIA, IVA, VA, and/or VIA, and (ii) Periods 2 and 3 of the Periodic Table;
X is one or more halogen atom;
n is 1 or more; and
m is 1 or more.

17. The method of claim 14, wherein the solid halogenated ammonium salt comprises NH₄CF₃SO₃ (ammonium triflate or NH₄OTf).

18. The method of claim 14, wherein the solid halogenated ammonium salt comprises NH₄PF₆ (ammonium hexafluorophosphate).

19. The method of claim 14, comprising contacting the solid halogenated ammonium salt with an amount of ammonia in a ratio of 0.6 to 5 for ammonia relative to the ammonium content of the solid halogenated ammonium salt.

20. The method of claim 14, comprising contacting the solid halogenated ammonium salt with the ammonia at (i) a temperature in a range from −80° C. to 60° C., and (ii) a pressure in a range from 0.2 atm to 5 atm.

21. The method of claim 20, wherein the ammonia comprises the gaseous ammonia, and the temperature is in a range from −30° C. to 60° C.

22. The method of claim 20, wherein the ammonia comprises the liquid ammonia, and the temperature is in a range from −80° C. to −30° C.

23. The method of claim 14, wherein substantially only the ammonia and one or more solid halogenated ammonium salts are contacted to form the liquid product.

24. The method of claim 14, wherein the liquid product comprises the liquefied ammonia-ammonium composition according to claim 1.

25. A method for forming ammonia, the method comprising:
subjecting the liquefied ammonia-ammonium composition according to claim 1 to temperature and pressure conditions sufficient to liberate gaseous ammonia from the composition.

26. The method of claim 25, further comprising:
recovering a solid halogenated ammonium salt after liberating the gaseous ammonia, the solid halogenated ammonium salt comprising a salt between the ammonium cation and the halogenated anion of the liquefied ammonia-ammonium composition; and
optionally contacting the recovered solid halogenated ammonium salt with gaseous ammonia to form a new liquid product.

27. The method of claim 25, further comprising:
transporting the liquefied ammonia-ammonium composition in liquid form from its original production facility to a different location for ammonia generation, prior to subjecting the liquefied ammonia-ammonium composition to the temperature and pressure conditions sufficient to liberate the gaseous ammonia from the composition.

28. A method for forming hydrogen, the method comprising:
electrolyzing the liquefied ammonia-ammonium composition according to claim 1 to form and liberate gaseous hydrogen (H₂) from the composition.

29. The method of claim 28, further comprising:
recovering a solid halogenated ammonium salt after liberating and forming the gaseous hydrogen, the solid halogenated ammonium salt comprising a salt between the ammonium cation and the halogenated anion of the liquefied ammonia-ammonium composition; and
optionally contacting the recovered solid halogenated ammonium salt with gaseous ammonia to form a new liquid product.
